(19) United States
(12) Patent Application Publication
(10) Pub. No.: US 2020/0242380 A1
(43) Pub. Date: Jul. 30, 2020

(54) ELECTRONIC DEVICE FOR GENERATING A SIGNAL INSIDE A VEHICLE AND ASSOCIATED VEHICLE, GENERATION METHOD AND COMPUTER PROGRAM

(71) Applicant: TRANSDEV GROUP, Issy-les-Moulineaux (FR)

(72) Inventor: Thomas DARNAUD, Versailles (FR)

(21) Appl. No.: 16/774,884

(22) Filed: Jan. 28, 2020

(30) Foreign Application Priority Data
Jan. 29, 2019 (FR) 1900792

(51) Int. Cl. G06K 9/00; G05D 1/00; G01C 21/34; G06K 9/32

(52) U.S. Cl. CPC G06K 9/00832; G05D 1/0088; G05D 2201/0213; G06K 9/3233; G01C 21/3438

(57) ABSTRACT

The invention relates to an electronic device for generating a signal inside a vehicle, in particular an autonomous motor vehicle, the vehicle being able to receive a set of passengers.

The device includes:
an identification module configured to identify a passenger of interest among the set of passengers inside the vehicle, via at least one sensor embedded in the vehicle;
a detection module configured to detect at least one event associated with the passenger of interest from at least one piece of information acquired from the at least one embedded sensor; and
a generating module configured to generate an information signal as a function of the detected event.

### CROSS-REFERENCE TO RELATED APPLICATIONS

This application is a U.S. non-provisional application claiming the benefit of French Application No. 19 00792, filed on Jan. 29, 2019, which is incorporated herein by reference in its entirety.

### FIELD OF THE INVENTION

The present invention relates to an electronic device for generating a signal inside a vehicle, in particular an autonomous motor vehicle.

The invention also relates to a vehicle, in particular an autonomous motor vehicle, able to receive a set of passengers inside the vehicle, the vehicle comprising such an electronic generating device and at least one embedded sensor coupled to the electronic generating device.

The invention also relates to a non-transitory computer-readable medium including a computer program including software instructions which, when executed by a computer, implement such a generating method.

The invention relates to the field of autonomous motor vehicles, in particular autonomous motor vehicles having a level of automation greater than or equal to 3 on the scale of the Organisation Internationale des Constructeurs Automobiles [International Organization of Motor Vehicle Manufacturers] (OICA).

The invention in particular relates to the field of public transportation. The vehicle is then for example a bus or a coach bus.

### BACKGROUND

A device is known for generating a signal inside a public transportation vehicle making it possible to provide general information to all of the passengers present in the vehicle, for example the announcement of the next stop of the vehicle.

However, the relevance of the information provided to the passengers inside the vehicle can further be improved.

### SUMMARY

The aim of the invention is then to propose an electronic generating device making it possible to further improve the relevance of the information sent to the passengers present inside such vehicles.

To that end, the invention relates to an electronic device for generating a signal inside a vehicle, in particular an autonomous motor vehicle, the vehicle being able to receive a set of passengers, the device including an identification module configured to identify a passenger of interest among the set of passengers inside the vehicle, via at least one sensor embedded in the vehicle; a detection module configured to detect at least one event associated with the passenger of interest from at least one piece of information acquired from the at least one embedded sensor; and a generating module configured to generate an information signal as a function of the detected event.

Thus, with the electronic generating device according to the invention, the identification module makes it possible to identify a passenger of interest among the set of passengers present in the vehicle. The detection module then makes it possible to detect an event associated with the passenger of interest that may affect the passenger of interest or the other passengers. The generating module makes it possible to generate an information signal as a function of the detected event. The electronic generating device according to the invention thus makes it possible to provide customized information directly to the passenger of interest or indirectly via an electronic supervision system. This is particularly advantageous when the vehicle is an autonomous motor vehicle due to the absence of driver able to communicate with the passengers.

According to other advantageous aspects of the invention, the electronic generating device comprises one or more of the following features, considered alone or according to all technically possible combinations:

the at least one embedded sensor is chosen from the group consisting of: an image sensor, a presence sensor; a sound sensor; an infrared sensor; a weight sensor and a temperature sensor;

the vehicle comprises at least one place able to receive a passenger among the set of passengers, and wherein at least one respective embedded sensor is associated with each place;

at least one of the sensors embedded in the vehicle is an image sensor, the detection module being configured to detect said event by a processing of image(s) coming from the image sensor associated with a machine learning method;

the detected event is chosen from the group consisting of: damage to the vehicle caused by the passenger of interest; a threatening behavior by the passenger of interest toward at least one other passenger; at least partial falling asleep by the passenger of interest; discomfort by the passenger of interest; panic by the passenger of interest; fear by the passenger of interest; injury by the passenger of interest; crying by the passenger of interest; and reduced mobility of the passenger of interest;

the detection module is configured to receive at least one complementary piece of information associated with the passenger of interest, the complementary piece of information being sent by a mobile terminal of one of the passengers, the detection module being configured to detect the event associated with the passenger of interest further from the complementary piece of information;

the device further comprises a location module configured to determine a position of the passenger of interest in the vehicle from at least one piece of information acquired from the at least one embedded sensor, the determined position preferably being a place of the vehicle that is occupied by the passenger of interest;

the device further comprises a counting module configured to count the number of passengers present inside the vehicle, the counting module being able to activate the identification module when the counting module counts at least two passengers present inside the vehicle; and

the vehicle comprises several embedded sensors, and the device comprises an acquisition module configured to acquire at least two separate pieces of information each sent by a respective embedded sensor, the identification module then being configured to identify the passenger of interest as a function of a combination of at least two of the received pieces of information.

The invention also relates to an autonomous motor vehicle able to receive a set of passengers inside the vehicle, the vehicle comprising such an electronic generating device and at least one embedded sensor coupled to the electronic generating device, the electronic generating device being as defined above.

The invention also relates to a method for generating a signal inside a vehicle, in particular an autonomous motor vehicle, the method being implemented by an electronic generating device, the vehicle being able to receive a set of passengers, the method including the following steps:

identifying a passenger of interest among the set of passengers inside the vehicle, via at least one sensor embedded in the vehicle;

detecting at least one event associated with the passenger of interest from at least one piece of information acquired from the at least one embedded sensor; and

generating an information signal as a function of the detected event.

The invention also relates to a non-transitory computer-readable medium including a computer program including software instructions which, when executed by a computer, implement a generating method as defined above.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic illustration of a transport system, comprising a plurality of vehicles according to the invention and an electronic surveillance device of vehicles;

FIG. 2 is a longitudinal vertical sectional view of one of the vehicles according to the invention;

FIG. 3 is a schematic illustration of an electronic generating device embedded in the vehicle of FIG. 2; and

FIG. 4 is a flowchart of a method, according to the invention, for generating a signal inside the vehicle of FIG. 1.

### DETAILED DESCRIPTION

The terms “vertical” and “horizontal” are to be understood generally relative to the typical directions of a vehicle traveling on a horizontal surface.

The term “longitudinal” is defined generally relative to a horizontal direction and substantially parallel to the movement direction of a vehicle.

The term “transverse” is defined generally relative to a horizontal direction and substantially orthogonal to the movement direction of a vehicle.

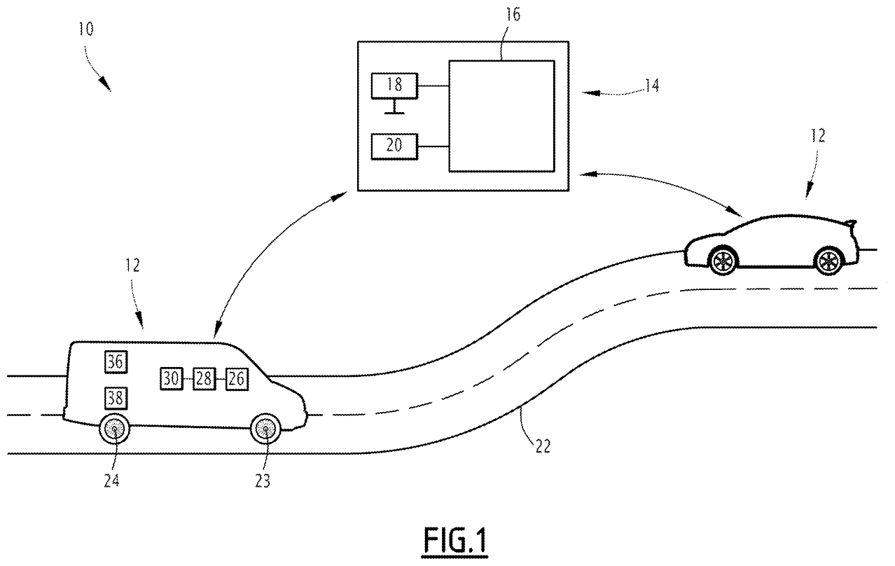

A transport system 10 is shown in FIG. 1. The transport system 10 comprises at least a vehicle 12 and an external platform 14 for supervision of the at least one vehicle 12.

The external supervision platform 14 comprises an electronic device 16 for monitoring said set of autonomous motor vehicles 12. In addition, the external supervision platform 14 comprises a display screen 18 and input/output means 20, such as a keyboard and a mouse, each being connected to the electronic surveillance device 16.

Each vehicle 12 is for example a motor vehicle, in particular a bus, configured to move in a traffic lane 22. The movement direction of the vehicle 12 defines a longitudinal axis A-A′. The vehicle 12 extends along the longitudinal axis A-A′.

As shown in FIG. 1, each vehicle 12 comprises, in a known manner, rear wheels 23, front wheels 24, a motor 26 mechanically connected via a transmission chain (not shown) to the rear 23 and/or front 24 wheels for the driving of said wheels 23 and/or 24 in rotation around their axis, a steering system (not shown), suitable for acting on the wheels 23 and/or 24 of the vehicle 12 so as to modify the orientation of its trajectory, and a braking system (not shown), suitable for exerting a braking force on the wheels 23, 24 of the vehicle 12.

Each motor vehicle 12 is typically made up of a traction and/or electric propulsion vehicle. To that end, the motor 26 is made up of an electric motor, and the vehicle 12 comprises an electric battery (not shown) electrically connected to the motor 26 to supply the motor 26 with electricity.

Each motor vehicle 12 is for example an autonomous vehicle. To that end, the motor vehicle 12 comprises an electronic autonomous driving device 28 suitable for controlling the vehicle autonomously by receiving information on the environment of the vehicle 12 by means of at least one sensor 30, also called environment sensor, and by acting on the motor 26, the steering system and the braking system, so as to modify the speed, the acceleration and the trajectory of the vehicle 12 in response to the received information. Each environment sensor 30 is for example a camera, a temperature sensor, a pressure sensor, a humidity sensor or a lidar.

Each autonomous motor vehicle 12 preferably has a level of automation greater than or equal to 3 on the scale of the Organisation Internationale des Constructeurs Automobiles (OICA). The level of automation is then equal to 3, that is to say, a conditional automation, or equal to 4, that is to say, a high automation, or equal to 5, that is to say, a full automation.

According to the OICA scale, level 3 for conditional automation corresponds to a level for which the driver does not need to perform continuous monitoring of the driving environment, while still having to be able to take back control of the autonomous motor vehicle 12. According to this level 3, a system for managing the autonomous driving, embedded in the autonomous motor vehicle 12, then performs the longitudinal and lateral driving in a defined usage case and is capable of recognizing its performance limits to then ask the driver to take back dynamic driving with a sufficient time margin.

The high level of automation 4 then corresponds to a level for which the driver is not required in a defined usage case. According to this level 4, the system for managing the autonomous driving, embedded in the autonomous motor vehicle 12, then performs the dynamic longitudinal and lateral driving in all situations in this defined usage case.

The full automation level 5 lastly corresponds to a level for which the system for managing the autonomous driving, on board the autonomous motor vehicle 12, performs the dynamic lateral and longitudinal driving in all situations encountered by the autonomous motor vehicle 12, throughout its entire journey. No driver is then required.

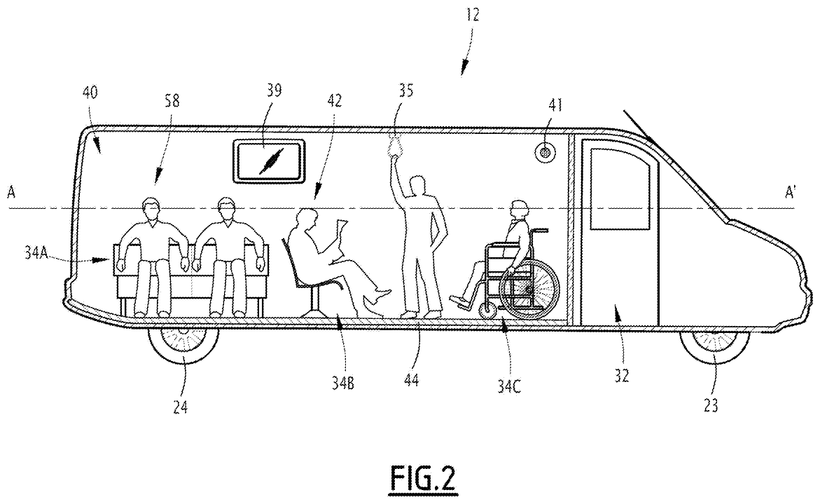

As shown in FIG. 2, the vehicle 12 further advantageously comprises at least one door 32, at least one place 34, at least one sensor 36, also called embedded sensor, and a device 38 for generating a signal inside the vehicle 12.

The vehicle 12 has an inner volume 40 configured to receive a set of passengers 42 and advantageously goods to be transported.

The vehicle 12 further advantageously comprises at least one display screen 39 and at least one speaker 41 that are positioned in the inner volume 40. Each screen 39 and each speaker 41 are able to communicate at least one piece of information to the passengers 42.

The inner volume 40 communicates with the outside of the vehicle 12 at least via the door 32. The door 32 is configured to allow the passengers and/or goods to pass from the outside to the inside of the inner volume 40, and vice versa. The inner volume 40 is in particular delimited by a floor 44, on which the passengers 42 and the goods move inside the inner volume 40. The door 32 is in particular a side door defining a transverse opening extending vertically from the floor 44.

Each place 34 is able to receive one of the passengers 42. The place 34 is in particular a seated place, for example a seat or a bench, or a standing place, for example a handle 35.

The place 34 is for example a longitudinal place 34A. The longitudinal place 34A refers to a seat or bench whose backrest extends substantially along the longitudinal axis A-A′. The longitudinal place 34A for example backs up on a side face of the vehicle 12.

In a variant, the place 34 is a transverse place 34B. The transverse place 34B refers to a seat or bench whose backrest extends substantially perpendicular to the longitudinal axis A-A′.

Additionally or in a variant, the place 34 is a location reserved for a person with reduced mobility 34C (denoted PRM hereinafter).

Additionally or in a variant, the place 34 is a handle 35 attached in the inner volume 40 of the vehicle 12, in particular the ceiling of the vehicle 12. Each handle 35 is able to be grasped by one of the passengers 42 standing on the floor 44 in order to guarantee his balance in case of sudden movement of the vehicle 12.

Additionally or in a variant, the vehicle 12 comprises longitudinal 34A places 34, transverse places 34B, places reserved for PRMs 34C and handles 35.

Each embedded sensor 36 is able to supply at least one piece of information relative to at least one of the passengers 42 inside the vehicle 12. Each embedded sensor 36 is chosen from the group consisting of: an image sensor, a presence sensor, a sound sensor, an infrared sensor, a weight sensor and a temperature sensor. Each embedded sensor 36 is coupled to the electronic generating device 38.

Advantageously, at least one respective embedded sensor 36 is associated with each place 34. As an optional addition, at least one respective embedded sensor 36 is associated with each handle 35.

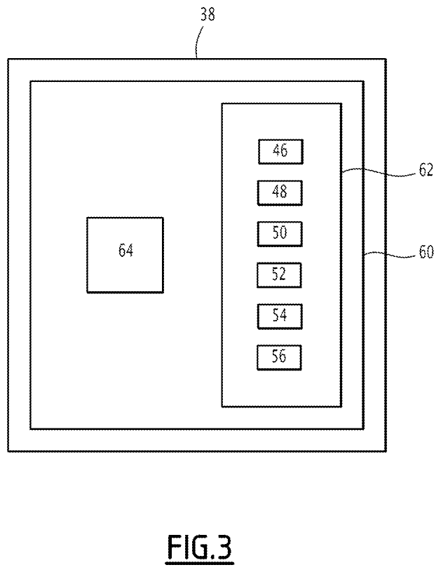

As shown in FIG. 3, the generating device 38 comprises an identification module 46, a detection module 48, a generating module 50 and advantageously an acquisition module 52, a location module 54 and a counting module 56.

The acquisition module 52 is configured to acquire at least one piece of information sent by an embedded sensor 36.

The acquisition module 52 is further advantageously configured to assign a reliability level to each received piece of information as a function of the received data type and the relevance of the embedded sensor 36 having sent the information. The reliability of an embedded sensor 36 is for example determined by measuring a margin of error on the measurements done by said embedded sensor 36. Advantageously, the acquisition module 52 is configured to consider the information sent by a sensor 36 only if the margin of error associated with the sensor 36 is below a predetermined threshold. The relevance of an embedded sensor 36 is determined as a function of a level of correlation of the information determined by the sensor 36 with an associated event. For example, an image escalated by an image sensor is more relevant than the temperature escalated by a temperature sensor in order to detect an associated event.

As an optional addition, the acquisition module 52 is further configured to assign a priority level to each received piece of information. The priority level of each piece of information is for example determined from the amplitude of the measurement done by the embedded sensor 36, for example the detection of a high-intensity sound or an abrupt movement.

The identification module 46 is configured to identify a passenger of interest 58 from the set of passengers 42 inside the vehicle 12, via at least one of the sensors 36 embedded in the vehicle 12.

Advantageously, the vehicle 12 comprises several embedded sensors 36, and the acquisition module 52 is configured to acquire at least two separate pieces of information each sent by a respective sensor 36. In particular, the acquisition module 52 is configured to acquire, for each embedded sensor 36, at least one respective piece of information sent by said sensor 36. The identification module 46 is configured to identify the passenger of interest 58 as a function of a combination of at least two of the received pieces of information. “Identify” refers to the fact that the identification module 46 has at least one piece of information making it possible to differentiate, that is to say, to distinguish, and additionally to locate, the passenger of interest 58 with respect to the rest of the passengers 12. In particular, the identification module 46 is able to identify the passenger of interest by associating him with one of the places 34 or one of the handles 35.

The detection module 48 is configured to detect at least one event associated with the passenger of interest 58 from at least one piece of information acquired from the at least one embedded sensor 36.

Advantageously, the detected event is chosen from the group consisting of:
damage to the vehicle 12 committed by the passenger of interest 58;
threatening behavior by the passenger of interest 58 toward another passenger 42;
at least partial falling asleep by the passenger of interest 58;
discomfort by the passenger of interest 58;
panic by the passenger of interest 58;
fear by the passenger of interest 58;
injury by the passenger of interest 58;
crying by the passenger of interest 58; and
reduced mobility of the passenger of interest 58.

Damage to the vehicle 12 is for example deterioration of one of the seats 34 or a wall of the vehicle 12, graffiti drawn in the vehicle 12, the presence of the feet of the passenger of interest 58 on one of the places 34, the throwing of waste in the vehicle 12, etc.

Threatening behavior is for example a physical or vocal attack by the passenger of interest 58 toward at least one other passenger 42. In particular, a threatening behavior is detected when the passenger of interest 58 is in possession of a bladed weapon, such as a knife, a cutter, or a firearm, such as a handgun, or when the passenger of interest 58 uses threatening or coarse language.

At least partial falling asleep by the passenger of interest 58 is associated with the closing of the eyes of the passenger of interest 58, snoring or deep breathing by the passenger of interest 58.

Discomfort is an alteration of the awareness of the passenger of interest 58 that may potentially cause a lack of consciousness by the passenger of interest 58. Discomfort is for example associated with sweating, paleness, convulsions, a fall, an immobilization of the passenger of interest 58, etc.

Panic is associated with anxiety by the passenger of interest 58, optionally with abrupt and disorganized movements by the passenger of interest 58 and shouts or a language characteristic of anxiety from the passenger of interest 58.

Panic is associated with strong fear by the passenger of interest 58, who is potentially petrified and remains immobile, associated with a face and language characteristic of fear from the passenger of interest 58.

An injury is a lesion to the body of the passenger of interest 58, such as a broken bone or a wound on his skin.

Crying is associated with tears coming from the eyes of the passenger of interest 38, optionally accompanied by vocal cries from the passenger of interest 58.

Reduced mobility of the passenger of interest 58 is associated with a hindrance of the passenger of interest 58 in his movements and displacements, temporarily or permanently, whether due to size, condition (health, excess weight, etc.), age, permanent or temporary disability, objects or people he is transporting, or apparatuses or instruments he must use to move.

In one advantageous embodiment, when at least one of the sensors 36 embedded in the vehicle 12 is an image sensor, the detection module 48 is configured to detect said event by a processing of image(s) coming from the image sensor associated with a machine learning method.

The machine learning method is for example based on a model using a statistical approach in order to make it possible to improve the performance of this method to resolve tasks without being explicitly programmed for each of these tasks. Machine learning includes two phases. The first phase consists of defining a model from data present in a database, called observations. The estimation of the model in particular consists of recognizing the presence of one or several objects in an image. This so-called learning phase is generally carried out prior to the practical use of the model. The second phase corresponds to the use of the model: the model being defined, new images can then be submitted to the model in order to obtain the object(s) detected in said images.

In particular, the machine learning method is able to detect objects associated with the passenger of interest 58 and characteristic of an event, such as marker or waste associated with damage to the vehicle 12, a knife or a weapon associated with threatening behavior, a cane or a wheelchair associated with reduced mobility of the passenger of interest 58.

The machine learning method is further able to detect the emotions of the passenger of interest 58 that are characteristic of an event such as pain associated with an injury, anxiety associated with panic or alarm associated with fear. The machine learning method is further able to detect the damage done by the passenger of interest 58 compared with images over time.

The machine learning model for example includes the implementation of a neural network. A neural network is generally made up of a series of layers, each of which takes its inputs on the outputs of the previous one. Each layer is made up of a plurality of neurons, taking their inputs on the neurons of the previous layer. Each synapses between neurons has an associated synaptic weight, such that the inputs received by a neuron are multiplied by this weight, then said neuron is added. The neural network is optimized owing to the adjustments of the different synaptic weights during the learning phase as a function of the images present in the initial database.

Additionally or in a variant, when at least one of the sensors 36 embedded in the vehicle 12 is a sound sensor, the detection module 48 is configured to detect said event by detecting sounds characteristic of an event. For example, the detection of expressions, such as “Help” or “S.O.S.”, is associated with panic by the passenger of interest 58 or a threatening behavior, and the detection of sobs is associated with crying or an injury of the passenger of interest 58.

Additionally, the detection module 48 is configured to receive at least one additional piece of information associated with the passenger of interest 58. The additional piece of information is sent by a mobile terminal of one of the passengers 42, in particular via a dedicated application. The additional piece of information is for example information indicating damage done by the passenger of interest 58 or threatening behavior by the passenger of interest 58. The detection module 48 is configured to detect the event associated with the passenger of interest 58 further from the additional piece of information.

As an optional addition, the detection module 48 is further configured to assign a priority level to each detected event. The priority level of each event is for example determined by the detected type of event and by the seriousness of the detected event. In particular, the likelier an event is to affect the safety of the passengers 42 of the vehicle 12, the higher a priority level the detection module 48 assigns to this event. For example, the detection of an injury of the passenger of interest 58 has a higher priority level than the detection of a passenger of interest 58 falling at least partially asleep.

Advantageously, the detection module 48 is able to send information relative to the detected event to the outside supervision platform 14 or to the electronic autonomous driving device 28, for example. The outside platform 14 or the electronic autonomous driving device 28 are then able to implement an action as a function of the detected device. For example, in case of injury of the passenger of interest 58, the outside platform 14 is able to notify the medical emergency services so as to bring an ambulance to the vehicle 12. In case of threatening behavior by the passenger of interest 58, the electronic autonomous driving device 28 is able to stop the vehicle 12 and open the door 32 so that the other passengers 42 can leave the vehicle 12.

The generating module 50 is configured to generate an information signal as a function of the detected event 48.

The information signal is intended for the passenger of interest 58 and/or the rest of the passengers 42. The information signal for example comprises a piece of information relative to the nature of the detected event, an information message indicating that an action relative to the detected event is in progress or a message with setpoint(s) for the passengers 42.

The information signal is for example a visual signal. The generating module 50 is then able to send the information signal to the display screen 39 located in the vehicle 12. In a variant or additionally, the information signal is a sound signal. The generating module 50 is then able to send the information signal to the speaker 41 located in the vehicle 12.

In one advantageous embodiment, the location module 54 is configured to determine a position of the passenger of interest 58 in the vehicle 12 from the at least one piece of information acquired from the at least one embedded sensor 36.

The determined position is preferably the place 34 that is occupied by the passenger of interest 58.

For example, the position of the passenger of interest 58 is determined by a processing of images coming from the image sensor or from information coming from the sensor 36 associated with said place 34 or handle 35, such as the presence sensor, the weight sensor or the temperature sensor.

The location module 54 is advantageously able to send the location of the passenger of interest 58 to the generating module 50 so that the information signal intended for the passenger of interest 58 is sent only to the screens 39 or the speakers 41 near the passenger of interest 58. “Proximity” refers to the fact that the screens or speakers are located at a distance of less than 2 m from the passenger of interest 58.

In a variant, the generating module 50 is able to send the information signal intended solely for the screens 39 or the speakers 41 at a distance from the passenger of interest 58. “At a distance” means that the screens or speakers are located at a distance greater than a threshold distance from the passenger of interest 58. The threshold distance is for example between 1 m and 3 m. Furthermore, the generating module 50 is able to adapt the threshold distance as a function of the detected event. This variant is particularly advantageous in the case of a detection of an attack by the passenger of interest 58 and where the information is intended for the other passengers 42 of the vehicle 12.

The counting module 56 is configured to count the number of passengers 42 present inside the vehicle 12.

Advantageously, the counting module 56 is able to activate the identification module 46 when the counting module 56 counts at least two passengers 42 present inside the vehicle 12.

For example, the counting module 56 is coupled to an infrared sensor located at the door 32 of the vehicle 12 or is able to perform a processing of images coming from the image sensor.

In the example of FIG. 3, the generating device 38 comprises an information processing unit 60 for example formed by a memory 62 and a processor 64 associated with the memory 62.

In the example of FIG. 3, the identification module 46, the detection module 48, the generating module 50, the acquisition module 52, the location module 54 and the counting module 56 are each made in the form of software, or a software component, executable by the processor 64. The memory 62 is then able to store identification software, detection software, generating software, acquisition software, location software and counting software. The processor 64 is then able to execute each of the software applications.

In a variant that is not shown, the identification module 46, the detection module 48, the generating module 50, the acquisition module 52, the location module 54 and the counting module 56 are each made in the form of a programmable logic component, such as an FPGA (Field Programmable Gate Array), or in the form of a dedicated integrated circuit, such as an ASIC (Application Specific Integrated Circuit).

When the generating device 38 is made in the form of one or several software programs, i.e., in the form of a computer program, it is further able to be stored on a medium, not shown, readable by computer. The computer-readable medium is for example a medium suitable for storing electronic instructions and able to be coupled with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

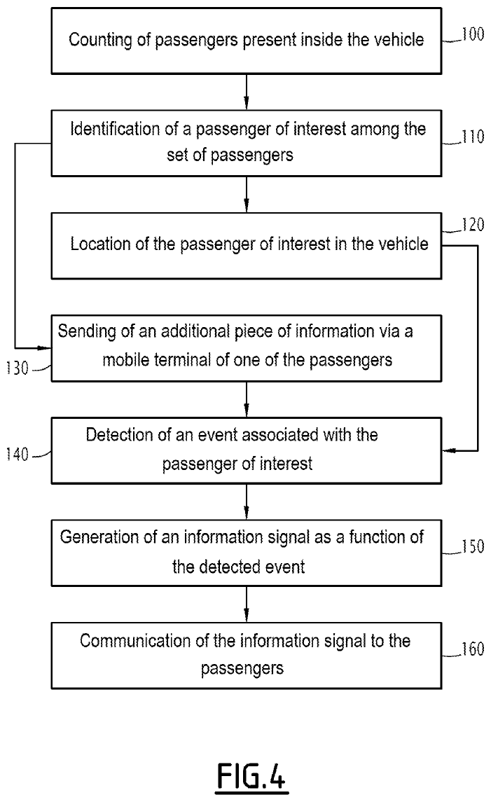

The operation of the electronic generating device 38 according to the invention will now be explained using FIG. 4 showing an organizational chart of the method, according to the invention, for generating a signal inside a vehicle 12, the method being implemented by the electronic generating device 38.

Initially, the autonomous motor vehicle 12 travels in the traffic lane 22 or is stopped.

In an optional initial step 100, the counting module 56 counts the number of passengers 42 present inside the vehicle 12.

When the counting module 56 counts at least two passengers 42 present inside the vehicle 12, the counting module 56 activates the identification module 46.

In a variant, the identification module 46 is activated at all times when the vehicle 12 is running.

Then, the method comprises a step 110 for identifying the passenger of interest 58 from the set of passengers 42 inside the vehicle 12 via the at least one sensor 36 embedded in the vehicle 12.

Advantageously, the identification module 46 identifies the passenger of interest 58 as a function of a combination of at least two of the pieces of information received by at least two embedded sensors 36.

The method next comprises an optional step 120 for locating the passenger of interest 58 by determining the position of the passenger of interest 58 in the vehicle 12 from one of the pieces of information acquired by the at least one embedded sensor 36. The determined position is preferably a place 34 of the vehicle 12 that is occupied by the passenger of interest 58 or a handle 35 grasped by the passenger of interest 58.

The piece(s) of information relative to the passenger of interest 58 are sent to the detection module 48.

In parallel with step 120, during an optional step 130, at least one additional piece of information associated with the passenger of interest 58 is sent by a mobile terminal of one of the passengers 42 present in the vehicle 12 to the detection module 48.

Then, during a step 140, the detection module 48 detects at least one event associated with the passenger of interest 58 from the at least one piece of information acquired via the at least one embedded sensor 36, and advantageously from the complementary information sent by the mobile terminal of one of the passengers 42.

Advantageously, the detected event is chosen from the group consisting of: damage to the vehicle 12 caused by the passenger of interest 58, a threatening behavior by the passenger of interest 58 toward at least one other passenger 42, at least partial falling asleep by the passenger of interest 58, discomfort by the passenger of interest 58, panic by the passenger of interest 58, fear by the passenger of interest 58, injury by the passenger of interest 58, crying by the passenger of interest 58, and reduced mobility of the passenger of interest 58.

The method next comprises a step 150 for generating an information signal intended for the passenger of interest 58 and/or the rest of the passengers 42 as a function of the event detected by the detection module 48. The information signal for example comprises a piece of information relative to the nature of the detected event, an information message indicating that an action relative to the detected event is in progress or a message with setpoints for the passengers 42.

The generating module 50 sends the information signal to the at least one display screen 39 or the at least one speaker 41 that are located in the vehicle 12.

Advantageously, the generating module 50 sends the information signal to one of the screens 39 or one of the speakers 41 located near the passenger of interest 58.

Then, during a step 160, the information signal is communicated to the passenger of interest 58 and/or the rest of the passengers 42 via the display screen 39 or the speaker 41.

One can then see that the present invention has a certain number of advantages.

The generating device 38 according to the invention makes it possible to generate more relevant information for the passengers 42 of the vehicle 12.

Indeed, the identification of a passenger of interest 58 among all of the passengers 42 makes it possible to perform customized processing for each passenger 42, and thus to obtain more relevant information for each passenger 42.

In particular, the detection of an event associated with this passenger of interest 58 and the generation of an information signal as a function of the detected event make it possible to obtain targeted information adapted to the situation of the passenger of interest 58 and the other passengers 42.

It is thus possible, using the location of the passenger of interest 58 in the vehicle 12, to communicate the information to him via the screen 39 or the speaker 41 nearby. The information communicated to each passenger 42 is thus customized and therefore more relevant.

Additionally, the detection from a combination of information from several embedded sensors 36 and/or from complementary information sent by a mobile terminal of one of the passengers 42, makes it possible to obtain a more precise detection of the event, and thus to provide information to the passengers 42 that better corresponds to the reality of the situation in the vehicle 12.

The invention therefore in particular makes it possible to improve the transport comfort for the passengers 42, for example by informing them or reassuring them following an event having taken place in the vehicle 12.

The invention also makes it possible to improve the safety of the passengers 42 by detecting incivilities or attacks having taken place in the vehicle 12 and informing the rest of the passengers 42 and the outside supervision platform 14 of this incident, so that a quick reaction can be provided.

1. An electronic device for generating a signal inside a vehicle, the vehicle being able to receive a set of passengers, the device including:
an identification module configured to identify a passenger of interest among the set of passengers inside the vehicle, via at least one sensor embedded in the vehicle;
a detection module configured to detect at least one event associated with the passenger of interest from at least one piece of information acquired from the at least one embedded sensor; and
a generating module configured to generate an information signal as a function of the detected event.

2. The device according to claim 1, wherein the at least one embedded sensor is chosen from the group consisting of: an image sensor; a presence sensor; a sound sensor; an infrared sensor; a weight sensor and a temperature sensor.

3. The device according to claim 1, wherein the vehicle comprises at least one place able to receive a passenger among the set of passengers, and wherein at least one respective embedded sensor is associated with each place.

4. The device according to claim 1, wherein at least one of the sensors embedded in the vehicle is an image sensor, the detection module being configured to detect said event by a processing of image(s) coming from the image sensor associated with a machine learning method.

5. The device according to claim 1, wherein the detected event is chosen from the group consisting of:
damage to the vehicle committed by the passenger of interest;
threatening behavior by the passenger of interest toward another passenger;
at least partial falling asleep by the passenger of interest;
discomfort by the passenger of interest;
panic by the passenger of interest;
fear by the passenger of interest;
injury by the passenger of interest;
crying by the passenger of interest; and
reduced mobility of the passenger of interest.

6. The device according to claim 1, wherein the detection module is configured to receive at least one complementary piece of information associated with the passenger of interest, the complementary piece of information being sent by a mobile terminal of one of the passengers, the detection module being configured to detect the event associated with the passenger of interest further from the complementary piece of information.

7. The device according to claim 1, wherein the device further comprises a location module configured to determine a position of the passenger of interest in the vehicle from at least one piece of information acquired from the at least one embedded sensor, the determined position preferably being a place of the vehicle that is occupied by the passenger of interest.

8. The device according to claim 1, wherein the device further comprises a counting module configured to count the number of passengers present inside the vehicle, the counting module being able to activate the identification module when the counting module counts at least two passengers present inside the vehicle.

9. The device according to claim 1, wherein the vehicle comprises several embedded sensors, and the device comprises an acquisition module configured to acquire at least two separate pieces of information each sent by a respective embedded sensor, the identification module then being configured to identify the passenger of interest as a function of a combination of at least two of the received pieces of information.

10. A vehicle able to receive a set of passengers, the vehicle comprising:
an electronic device for generating a signal inside a vehicle; and
at least one embedded sensor coupled to the electronic generating device; wherein the electronic generating device is according to claim 1.

11. A method for generating a signal inside a vehicle, the method being implemented by an electronic generating device, the vehicle being able to receive a set of passengers, the method including the following steps:
identifying a passenger of interest among the set of passengers inside the vehicle, via at least one sensor embedded in the vehicle;
detecting at least one event associated with the passenger of interest from at least one piece of information acquired from the at least one embedded sensor; and
generating an information signal as a function of the detected event.

12. A non-transitory computer-readable medium including a computer program comprising software instructions which, when executed by a computer, carry out a generation method according to claim 11.
